(19) United States
(12) Patent Application Publication
(10) Pub. No.: US 2002/0190954 A1
(43) Pub. Date: Dec. 19, 2002

(54) Trackball

(76) Inventor: Jerry Chen, Taipei Hsien (TW)

Correspondence Address: RABIN & CHAMPAGNE, PC, 1101 14TH STREET, NW, SUITE 500, WASHINGTON, DC, 20005, US

(21) Appl. No.: 09/879,139

(22) Filed: Jun. 13, 2001

(51) Int. Cl. G09G 5/08

(52) U.S. Cl. 345/167

(57) ABSTRACT

A trackball includes a first circuit module adapted to control the amount and direction of movement of a pointer on a computer screen upon rotation of a ball on the first circuit module, and a second circuit module disposed below the first circuit module and adapted to make a menu selection upon pressing of the ball.

### BACKGROUND OF THE INVENTION

The present invention relates to a trackball and, more particularly, to a such a trackball, which enables the operator to manipulate objects on the screen and to make menu selections simply by means of rotating and pressing the ball.

In early days, the pointer on the computer screen of a computer system is controlled by the up, down, left and right keys. This pointer control method does not fit window operation environment. Therefore, optical mouse was developed. The mouse is connected to the computer by a wire, and incorporates one or more buttons that can be pressed. Moving the mouse across a flat surface causes a corresponding movement of the pointer. In this way, the operator can manipulate objects on the screen and make menu selections. The mouse is still not satisfactory in function because it must be moved across a flat surface when controlling the pointer on the computer screen. In order to eliminate this drawback, trackball was developed.

FIG. 1 shows a trackball according to the prior art. This structure of trackball comprises a circuit module 1a, a two-dimensional optical shaft unit 2a, a ball holder 3a, a ball 4a, and a switch 5a. This trackball carries out the same function as a mouse, but remains stationary. However, when making a menu selection, the user must shift the finger to the enter button and then press the enter button. After a menu selection, the user must shift back the finger from the enter button to the ball again. This operation method is still not satisfactory in function.

### SUMMARY OF THE INVENTION

The present invention has been accomplished under the circumstances in view. It is the main object of the present invention to provide a trackball, which enables the user to directly make a menu selection simply by pressing the ball without leaving the finger from the ball. According to the present invention, the trackball comprises a first circuit module pivoted to upright support means in the housing of the trackball and adapted to control the amount and direction of movement of a pointer on a computer screen upon rotation of a ball on the first circuit module, and a second circuit module disposed below the first circuit module with a switch thereon supporting the free end of the first circuit module and adapted to make a menu selection upon pressing of the ball.

### BRIEF DESCRIPTION OF THE DRAWINGS

FIG. 1 is a perspective view showing the internal structure of a prior art trackball.

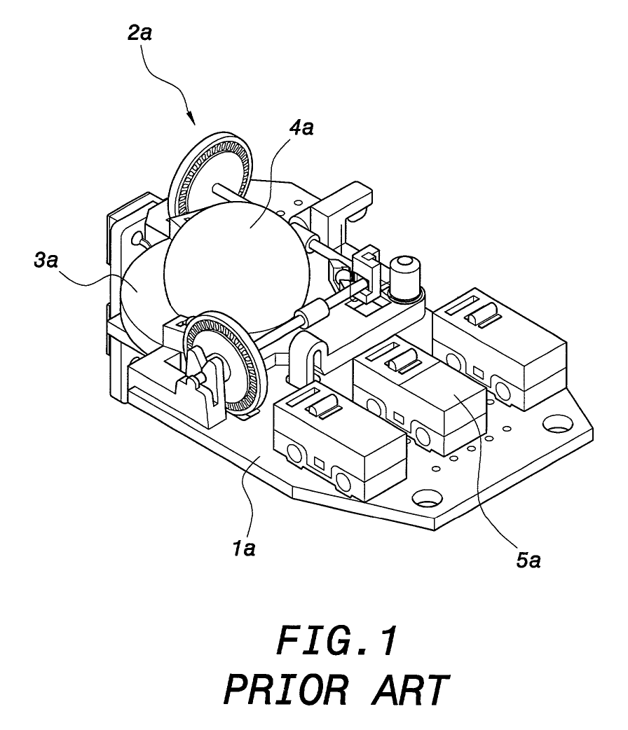

FIG. 2 is an elevational view of a trackball constructed according to the present invention.

FIG. 3 is a perspective view of the present invention, showing the top cover shell of the housing removed from the bottom cover shell.

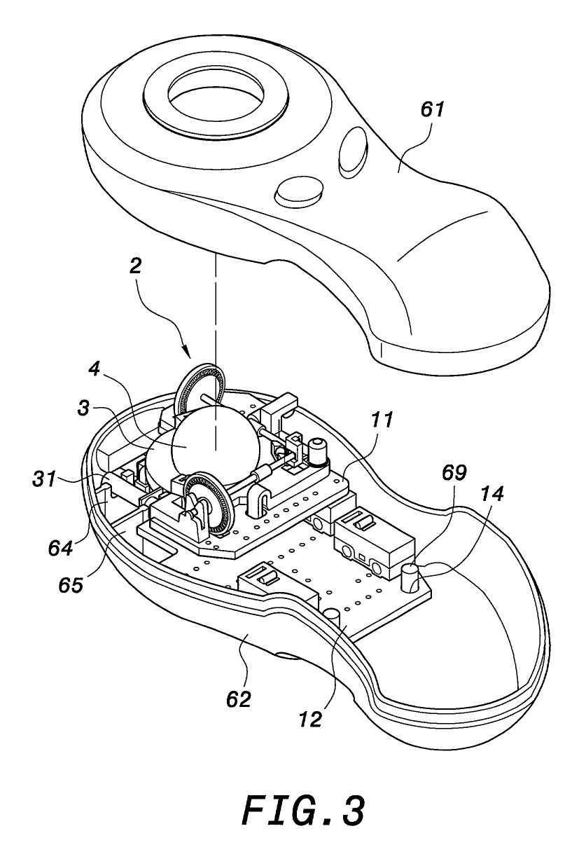

FIG. 4 is an exploded view of the present invention (the housing excluded).

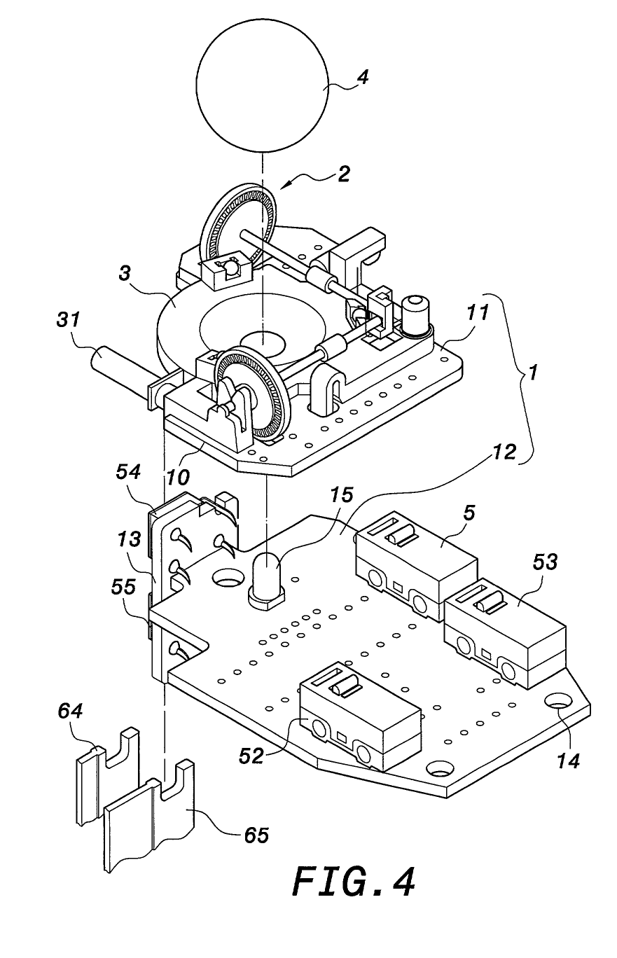

FIG. 5 is a longitudinal view in section in an enlarged scale of a part of the present invention.

FIG. 6 is similar to FIG. 5 but showing the trackball operated.

FIG. 7 is a transverse view in section in an enlarged scale of a part of the present invention.

FIG. 8 is similar to FIG. 7 but showing the trackball operated.

### DETAILED DESCRIPTION OF THE PREFERRED EMBODIMENT

Referring to FIGS. from 2 through 5, a trackball is shown comprising a housing 6 formed of a top cover shell 61 having a circular opening 63 and a bottom cover shell 62, and a circuit module unit, which is comprised of a first circuit module 11 and a second circuit module 12 respectively mounted in the housing 6 at different elevations. The first circuit module 11 incorporates a two-dimensional optical shaft unit 2 and a ball 4. The aforesaid statement is similar to a conventional trackball. The features of the present invention are outlined hereinafter.

The first circuit module 11 comprises a horizontal pivot shaft 31 disposed at one side 10 thereof and pivotally supported on upright supports 64;65 inside the bottom cover shell 62, and ball holder 3 adapted to support the ball 4, i.e., the first circuit module 11 has a fixed end pivoted to the upright supports 64;65 of the bottom cover shell 62 and a free end suspending above the second circuit module 12. The ball 4 is a transparent spherical member rotatably mounted in the ball holder 3 and partially projecting out of the circular opening 63 of the top cover shell 61 of the housing 6.

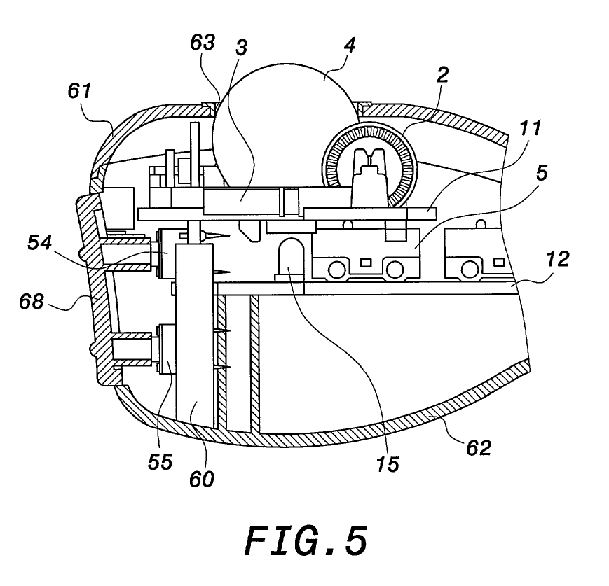

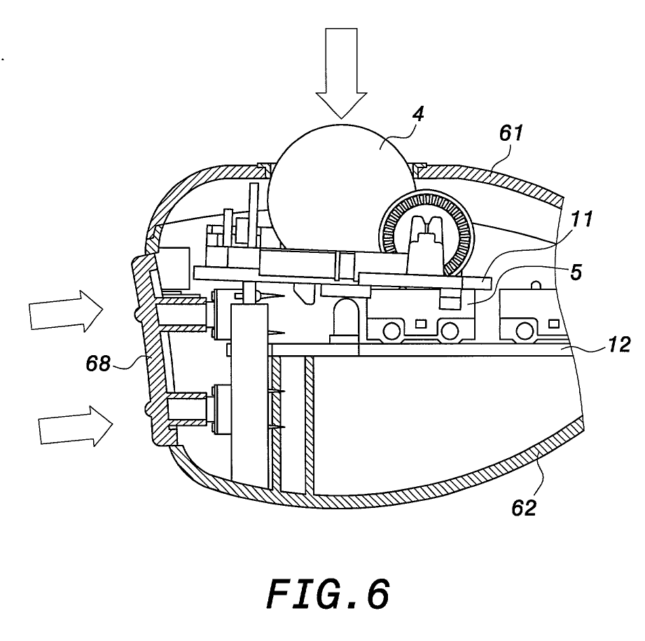

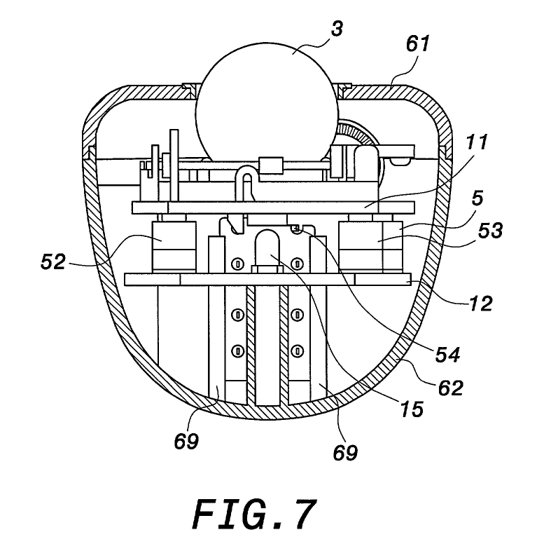

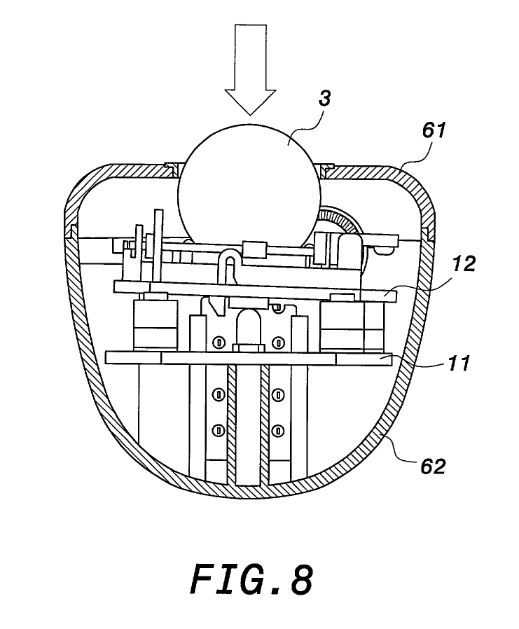

The second circuit module 12 comprises a first switch 5 functions as enter button to make a menu selection. The first switch 5 is disposed at one side opposite to the pivot shaft 31 of the ball holder 3 and adapted to support the free end of the first circuit module 11, i.e., the first circuit module 11 is supported on three bearing points above the second circuit module 12. These three bearing points include a first bearing point at the first switch 5 of the second circuit module 12, and second and third bearing points at the upright supports 64;65 of the bottom cover shell 62. In other words, the first circuit module 11 has a fixed end pivoted to the upright supports 64;65 and a free end supported on the first switch 5. When the user presses the ball 4, the first circuit module 11 is lowered against the first switch 5 (see FIGS. 5 and 6 or FIGS. 7 and 8), thereby causing the first switch 5 to output a signal to the connected computer to make a menu selection.

The second circuit module 12 further comprises a second switch 52 and a third switch 53 corresponding to the left button 66 and right button 67 of the top cover shell 61, a fourth switch 54 and a fifth switch 55 at the front side thereof corresponding to the front button 68 of the bottom cover shell 62. By means of pressing either end of the front button 68 of the bottom cover shell 62, the fourth switch 54 or the fifth switch 55 is triggered to output a respective signal to the computer. The fourth switch 54 and the fifth switch 55 are mounted on a third circuit module 13, which is vertically fastened to the front side of the second circuit module 12 and inserted into a plug hole 60 inside the bottom cover shell 62. The second circuit module 12 has two rear positioning holes 14 respectively coupled to respective locating rods 69 inside the bottom cover shell 62. During operation, the fourth switch 54 limits the down stroke of the first circuit module 11 when the user presses the ball 4 to lower the first circuit module 11 against the first switch 5. After each down stroke of the first circuit module 11, the spring power of the spring-supported press button of the first switch 5 immediately forces the first circuit module 11 upwards to its former position.

The second circuit module 12 comprises a LED (light emitting diode) 16 aimed at the center through hole 32 of the ball holder 3 and the bottom side of the ball 4. During the operation of the trackball, the light of the LED 16 passes through the transparent ball 4, producing a lighting effect. The housing 6 is orthopedically engineered to fit the palm of the hand for comfortable operation.

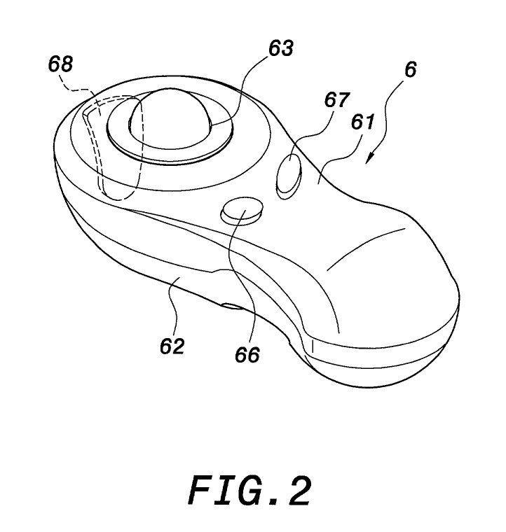

A prototype of trackball has been constructed with the features of FIGS. 2˜8. The trackball functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A trackball comprising:
a housing, said housing comprising a circular opening and at least one upright support disposed on the inside;
a first circuit module mounted inside said housing, said first circuit module comprising a fixed end pivoted to said at least one upright support of said housing, a free end, two-dimensional optical shaft unit, a ball holder, and a ball rotatably supported on said ball holder and partially projecting out of the circular opening of said housing;
a second circuit module fixedly mounted inside said housing and spaced below said first circuit module; and
a switch mounted on said second circuit module and supporting the free end of said first circuit module above said second circuit module and adapted to output a signal to make a menu selection upon pressing of said ball by the user to turn said first circuit module about said at least one upright support of said housing.

2. The trackball of claim 1 wherein said second circuit module comprises a light emitting diode aimed at a bottom side of said ball and controlled to emit light through said ball.

3. The trackball of claim 1 wherein said second circuit module further comprises a second switch and a third switch corresponding to left and right buttons of said housing.

4. The trackball of claim 3 wherein said second circuit module further comprises a fourth switch and a fifth switch corresponding to a front button of said housing.
